(19) United States
(12) Patent Application Publication
(10) Pub. No.: US 2002/0054073 A1
(43) Pub. Date: May 9, 2002

(54) Electronic book with indexed text-to-audio switching capabilities

(76) Inventor: Henry C. Yuen, Pasadena, CA (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/873,821

(22) Filed: Jun. 4, 2001

Related U.S. Application Data
(60) Provisional application No. 60/209,113, filed on Jun. 2, 2000.

(51) Int. Cl. G09G 5/00

(52) U.S. Cl. 345/727

(57) ABSTRACT

An indexing scheme is created which correlates text to audio in a manner which allows the reader of an electronic book, magazine or other form of reading system may switch from reading text to listening to an audio version of the text in a seamless manner. A first index is generated prior to the storage of a text database. Preferably, this index attaches codes to words, sentences, and perhaps larger text segments such as paragraphs, pages, or chapters. A second index is created at the time of creation of the audio content. Again, codes are preferably created with respect to words and larger segments such as sentences, paragraphs, pages or chapters. The two indexes are synchronized as the material is presented to the user. Given that both the text and audio are preferably indexed in terms of words and larger portions of the material, differences between the recorded audio portion and the corresponding text are accommodated by finding the best match at the finest resolution.

### REFERENCE TO RELATED APPLICATION

This application claims priority from U.S. provisional patent application Ser. No. 60/209,113, filed Jun. 2, 2000, the entire contents of which are incorporated herein by reference.

### FIELD OF THE INVENTION

The present invention relates generally to electronic books. More particularly, the invention relates to an electronic book, magazine or other form of reading system which allows a person to switch from reading text to listening to an audio book in a seamless manner.

### BACKGROUND OF THE INVENTION

Inventions directed to electronic book technology date back to the 1970s. According to U.S. Pat. No. 4,159,417, the contents of a book, magazine or the like, are digitally encoded onto a memory, and the memory is removably insertable into a portable book-like apparatus whereby the encoded information can be displayed on a screen of the apparatus. Although the specific embodiment described is a holographic memory system, this patent also contemplates the use of other digital, nonvolatile memories, including microfilm, graphically encoded cards or discs, magnetic-bubble memories, as well as other optical or electronic media.

Over the last two decades, numerous other patents have been awarded which describe improvements in fundamental ebook technology, including advances in data communications and human interaction. U.S. Pat. No. 5,534,888 describes a hinged, book-like housing with electronics including a processor for manipulating data, a memory for data storage, an input for entering data, and an output for removing data. A plurality of display pages are provided which may be turned for a continual flow of data, text, video, and graphics.

As a result of such advances, electronic books are becoming a technological and economical reality. Current commercially available examples include the Softbook Reader and the Rocket eBook. Some of these devices contain audio capabilities; for example, the Rocket eBook plans to have a version with full MP3 capabilities. However, electronic books or e-books continue to be compared with conventional books on factors such as readability and weight, thereby slowing acceptance. The need remains for electronic books having more advanced features. Such advances would hopefully defeat comparisons with conventional books and justify the higher upfront investment required for the ebook.

### SUMMARY OF THE INVENTION

Broadly, this invention allows the reader of an electronic book, magazine or other form of reading system to switch from reading text to listening to an audio version of the text in a seamless manner. In solving this problem, an indexing scheme is created which correlates the text to the audio in a manner which allows the reader/listener to achieve continuity while switching from one mode to another.

According to the invention, a first index is generated prior to the storage of a text database. Preferably, this index attaches codes to words, sentences, and perhaps larger text segments such as paragraphs, pages, or chapters. A second index is created at the time of creation of the audio content. Again, codes are preferably created with respect to words and larger segments such as sentences, paragraphs, pages or chapters.

The first index may correspond to an explicit or implicit index of the text. Explicit index refers to an index attached to the text, and implicit index refers to certain implicit measurements, such as the cumulative word count, page count, or paragraph count, or similar counting schemes, or a combination thereof.

The two indexes are synchronized as the material is presented to the user. Given that both the text and audio are preferably indexed in terms of words and larger portions of the material, differences between the recorded audio portion and the corresponding text are accommodated by finding the best match at the finest resolution. For example, if the speech is word-for-word verbatim, the switch between the two is perfectly seamless. If, however, the spoken aspect “leaves out” certain words, changes words, and even sentences, the associated codes are analyzed for the best correspondence, and the switching occurs on that basis.

Various extensions are also disclosed, including the simultaneous as opposed to separate textual and audio modes. A visual mode, including graphics and/or motion video may also be accommodated. The synchronization of an auxiliary audio or video presentation, such as music, sound effect or graphics and video presentation in correspondence to the text), may be accomplished automatically or by selection of user. For example, when a certain page is turned, certain sound effects or pronunciations are presented either automatically or through user selection.

### BRIEF DESCRIPTION OF THE DRAWINGS

FIG. 1 is a diagram that illustrates the programming and operation of an electronic book according to the invention.

### DETAILED DESCRIPTION OF THE INVENTION

This invention allows the reader of an electronic book, magazine or other form of reading system to switch from reading text to listening to an audio version of the text in a seamless manner.

The user, while reading, may switch to the audio mode in a plurality of different ways. The user may indicate directly that they wish to switch, or alternatively, the reader may explicitly or implicitly designate a point in the text for the switching to be effected. “Explicit” refers to the user actively selecting a word, sentence of paragraph at which point the switching is to be effected, whereas “implicit” refers to doing no farther than to indicate the desired switch while reading a particular page. Of course, while listening to the audio book, the user may switch to a textual mode by indicating the desire to switch to that mode of operation.

In the preferred embodiment, the switching is effected through the matching of the indices on the textual and audio contents. However, since some current audio books are not verbatim with respect to text versions, this presents a problem in the switching, since it is not apparent how the text and the audio can synchronize. This invention solves this problem by creating an indexing scheme which correlates the text to the audio in a manner which allows the reader/listener to achieve continuity while switching from one mode to another.

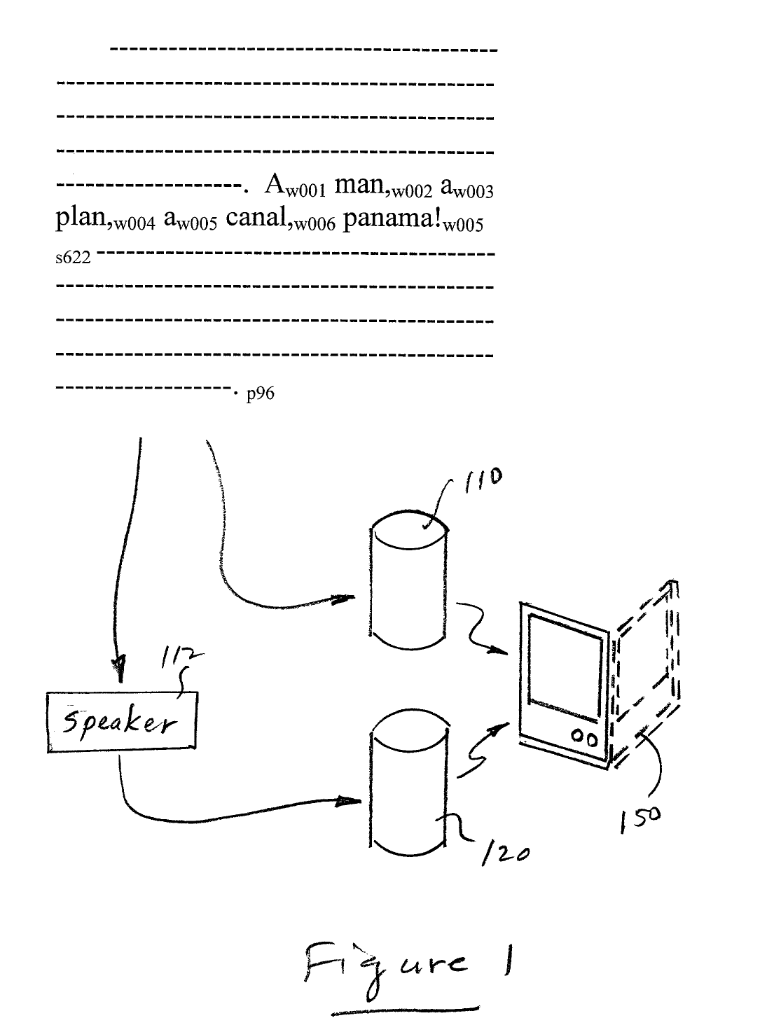

As shown in FIG. 1, a textual index is automatically generated prior to storage text database 110. Preferably, this index attaches codes to words (wxxx), sentences (sxxx), and perhaps larger text segments such as paragraphs (pxxx), pages, or chapters. An audio index is created in conjunction with a speaker 112 for storage within an audio database 120. Again, codes are preferably created with respect to words and larger segments such as sentences, paragraphs, pages or chapters. As discussed below, databases 110 and 120 may, or may not form a portion of physical electronic book 150.

Henceforth, the text index will be called the “first index,” and the audio index will be called the “second index.” The first index may correspond to an explicit or implicit index of the text. Explicit index refers to an index attached to the text, and implicit index refers to certain implicit measurements, such as the cumulative word count, page count, or paragraph count, or similar counting schemes, or a combination thereof.

According to the invention, the two indexes are synchronized as the material is presented to the user. Given that both the text and audio are preferably indexed in terms of words and larger portions of the material, differences between the recorded audio portion and the corresponding text are accommodated by finding the best match at the finest resolution. For example, if the speech is word-for-word verbatim, the switch between the two is perfectly seamless. If, however, the spoken aspect “leaves out” certain words, changes words, and even sentences, the associated codes are analyzed for the best correspondence, and the switching occurs on that basis.

The synchronization process also includes a number of special features according to the invention, as follows: (1) it has the ability to synchronize a word, a sentence or a paragraph, or as selected by the user, (2) it has the ability to repeat a certain portion of the content (“short rewind”) to make sure that the flow of the story is preserved, (3) in the case of switching from textual to audio, an ability to imbed and call up a brief update summary of the story line to preserve continuity, especially in the case where the audio content is not verbatim.

One possible implementation of the invention is an electronic device which stores both textual and audio presentation of the same creative piece. For example, both the textual content and the audio for a novel may be stored in the same device. Alternatively, more than one electronic device may be connected via wired or wireless communication links, or a combination of both, which collective stores the textual and audio content of the same creative piece. For example, the text is stored in the eBook, while the audio portion is stored in an auxiliary device connected to the eBook by a wire or wireless link like IRDA. Or the text may stored in the eBook, with the audio portion being stored in a remote server connected by wireless links or a series of wired or wireless links.

The index scheme may itself be contained in the device, or a system of connected devices, while nevertheless allowing the synchronization described herein to be effected. A command may be given to the device or the system of connected devices to effect a switching of the mode (from textual to audio and vice versa), with appropriate electronic and programming being operatively provided to effect the switching of the mode.

Having described the preferred embodiments, it will be appreciated to one of skill that various extensions are possible in using the invention, including the simultaneous as opposed to separate textual and audio modes. A visual mode, including graphics and/or motion video may also be accommodated. The synchronization of an auxiliary audio or video presentation, such as music, sound effect or graphics and video presentation in correspondence to the text), may be accomplished automatically or by selection of user. For example, when a certain page is turned, certain sound effects or pronunciations are presented either automatically or through user selection.

I claim:

1. A method of switching between text and audio in an electronic book, comprising the steps of:
providing the text and audio in indexed form;
receiving a request from a user to switch from text to audio or vice-versa; and
synchronizing the switching in accordance with the indexing of the text and audio.

2. The method of claim 1, wherein the step of synchronizing is based on a word, a sentence or a paragraph, or as selected by the user.

3. The method of claim 1, further including the step of repeating a certain portion of the content (“short rewind”) to make sure that the flow of the story is preserved.

4. The method of claim 1, further including the step of storing and retrieving a brief update summary of the story line to preserve continuity, especially in the case where the audio content is not verbatim.
